(19) United States
(12) Patent Application Publication
(10) Pub. No.: US 2017/0305126 A1
(43) Pub. Date: Oct. 26, 2017

(54) SKIN MATERIAL AND METHOD FOR PRODUCING SKIN MATERIAL

(71) Applicant: KYOWA LEATHER CLOTH CO., LTD., Shizuoka (JP)

(72) Inventors: Masato TAKESHITA, Hamamatsu-Shi, Shizuoka (JP); Kenji KUBO, Hamamatsu-shi, Shizuoka (JP)

(21) Appl. No.: 15/512,506

(22) PCT Filed: Dec. 17, 2015
(86) PCT No.: PCT/JP2015/085410

§ 371 Date: Mar. 17, 2017

(30) Foreign Application Priority Data
Jan. 15, 2015 (JP) 2015-005630

(51) Int. Cl. B32B 27/12; B32B 7/12; B32B 37/06; B32B 37/12; B32B 5/02; B32B 37/14; B32B 38/04; B60N 2/58; B60R 13/02

(52) U.S. Cl. CPC B32B 27/12; B32B 5/026; B32B 7/12; B32B 37/06; B32B 37/12; B32B 37/14; B32B 5/024; B32B 2605/003; B60N 2/58; B60R 13/02; B60R 13/0212; B60R 13/0256; B32B 2038/047

(57) ABSTRACT

A skin material containing, in the following order: a base fabric that is configured to contain fibers having a synthetic resin coating layer, wherein fibers adjacent to each other in the base fabric are at least partially fused with each other; and an adhesive layer and a skin layer, which are provided at a surface of at least one side of the base fabric in this order from the base fabric, the skin material having a plurality of ventilation holes passing through the skin material in a thickness direction.

### TECHNICAL FIELD

The invention relates to a skin material and a method for producing a skin material.

### BACKGROUND ART

Synthetic resin skin materials excellent in durability have been heavily used for automobile interior parts (e.g. instrument panels, door trims, seats, ceilings, etc.), interior parts for railway vehicles and aircraft (e.g. trims, seats, ceilings, etc.), furniture, shoes, footwear, bags, interior/exterior members for buildings, outer covering materials and backing materials for clothes, wallcovering materials, and the like, in place of natural leathers or fibrous sheets.

For example, in the case of automobile interior parts, it has become increasingly important to impart luxuriousness to interior skin materials used for interior parts of automobile along with upgrading of vehicles. In addition, skin materials are required to have breathability equal to or higher than that of natural leather.

In order to obtain moisture permeability and breathability, perforation processing is performed on a layered sheet used as synthetic leather, which is one aspect of skin materials. However, by perforation processing of the synthetic leather, the strength of the synthetic leather such as tearing strength, surface abrasion strength and the like may be lowered compared to the strength before performing the perforation processing.

In general, a skin material contains a fabric used as a base material, a urethane foam layer, provided at a surface of at least one side of the fabric, for imparting cushioning property, and a skin layer at the outermost surface for imparting a design property.

As one aspect of skin materials, for example, there is disclosed a decorative layered sheet having a colored layer and an opaque skin layer having a different color from the that of the colored layer and being layered thereon, wherein plural holes passing through at least the colored layer and the opaque skin layer are provided, and a color of the colored layer below the opaque skin layer can be visually confirmed through the holes when viewed from the skin layer side (for example, see Japanese Patent Application Laid-Open (JP-A) No. H11-256483).

### SUMMARY OF INVENTION

### Technical Problem

Generally, synthetic leather, which is one aspect of a skin material, is classified roughly into dry synthetic leather, which is formed by adhering an unprocessed base fabric and a skin to each other, and wet synthetic leather, which is formed by applying a wet processing to a base fabric to form a wet base and adhering the wet-processed base fabric, for example a base fabric impregnated with a resin, and a skin to each other.

In the case of the synthetic leather in which a base fabric is impregnated with a resin, the strength of the base fabric is improved by the impregnated resin, and the yarn fraying of the base fabric in the case perforation processing is performed is suppressed. However, when impregnating a base fabric with a synthetic resin in an amount sufficient for improving the strength and suppressing the yarn fraying, there may be a problem that the weight of the produced synthetic leather becomes heavier.

It is also important for a skin material to be lightweight. Therefore, for interior materials of vehicles and the like, a skin material obtained by a dry method, which is lightweight and excellent in flexibility, is frequently used.

A skin material obtained by a dry method may be, depending on the types of the base fabric, susceptible to distortion of holes or lowering of the strength when perforation processing is carried out for the purpose of aeration and the like. Further, when a perforation processing is applied to the base fabric, there may be disadvantages in appearance. For example, fraying of fibers constituting the base fabric may be seeable through the holes, or the holes may be distorted due to the softness of the synthetic leather.

An object of the invention is to provide a skin material having ventilation holes, and having high moisture permeability, high breathability, sufficient strength as a skin material, and excellent appearance of the ventilation holes.

Another object of the invention is to provide a method for producing a skin material having ventilation holes, and having high moisture permeability, high breathability, sufficient strength as a skin material, and excellent appearance of the ventilation holes, by simple process.

### Solution to Problem

As a result of investigations, the inventors of the invention found that the above problems can be solved by using a base fabric containing fibers having a synthetic resin coating layer, wherein fibers adjacent to each other are at least partially fused with each other. The invention was completed based on these findings.

The invention includes the following embodiments.

<1> A skin material containing, in the following order: a base fabric containing fibers having a synthetic resin coating layer, wherein fibers adjacent to each other in the base fabric are at least partially fused with each other; and an adhesive layer and a skin layer, which are provided at a surface of at least one side of the base fabric in this order from the base fabric, the skin material having a plurality of ventilation holes passing through the skin material in a thickness direction.
<2> The skin material according to <1>, wherein the fibers contain at least one kind of core fiber selected from the group consisting of a polyester fiber, a polyamide fiber, a polyurethane fiber, a rayon fiber, a nylon fiber, and a cotton fiber, and a synthetic resin coating layer containing a synthetic resin having a melting point of from 120° C. to 180° C.
<3> The skin material according to <1> or <2>, wherein the base fabric is obtained by fusing, at least partially with each other, fibers adjacent to each other, the fibers adjacent to each other being among fibers contained in a fabric obtained by knitting or weaving using a yarn containing the fibers having the synthetic resin coating layer.
<4> A method for producing a skin material, including the steps of: layering a skin layer and an adhesive layer, in this order, at a surface of a releasing material, from a side of the releasing material; preparing a base fabric containing fibers having a synthetic resin coating layer; adhering the base fabric and the adhesive layer to each other by bringing the adhesive layer of the releasing material, which is layered with the skin layer and the adhesive layer, into contact with a surface of at least one side of the base fabric; heating the base fabric, the adhesive layer, the skin layer, and the releasing material to form the adhesive layer, the skin layer, and the releasing material, in this order from the base fabric, at a surface of at least one side of the base fabric, and peeling off the releasing material from a surface of the skin material to form a layered body; perforating the layered body to form a plurality of ventilation holes passing through the layered body in a thickness direction; and carrying out heating to a temperature equal to or higher than a softening temperature of a synthetic resin contained in the synthetic resin coating layer to fuse, at least partially with each other, fibers having the synthetic resin coating layer, the heating being carried out before the step of perforating the layered body to form the ventilation holes.
<5> The method for producing a skin material according to <4>, wherein the step of preparing the base fabric containing the fibers having the synthetic resin coating layer is a step of preparing the base fabric using a yarn containing the fibers having the synthetic resin coating layer, and wherein the step of carrying out heating to a temperature equal to or higher than a softening temperature of a synthetic resin contained in the synthetic resin coating layer to fuse, at least partially with each other, fibers having the synthetic resin coating layer is carried out after the step of preparing the base fabric and before the step of adhering the base fabric and the adhesive layer to each other.

### Advantageous Effects of Invention

According to the invention, a skin material having ventilation holes, and having high moisture permeability, high breathability, sufficient strength as a skin material, and excellent appearance of the ventilation holes is provided.

In addition, according to the invention, a method for producing a skin material having ventilation holes, and having high moisture permeability, high breathability, sufficient strength as a skin material, and excellent appearance of the ventilation holes is provided.

### BRIEF DESCRIPTION OF DRAWINGS

FIG. 1 is a schematic cross-sectional view of one embodiment of a skin material according to the invention.

FIG. 2A is a schematic view of the state of an aspect of fibers used for a skin material according to the invention before heat treatment.

FIG. 2B is a schematic view of the state of an aspect of fibers used for a skin material according to the invention after heat treatment.

FIG. 3A is a microscopic photograph showing a cross section of fibers contained in a base fabric used for a skin material in the embodiment before heat treatment.

FIG. 3B is a microscopic photograph showing a cross section of fibers contained in a base fabric used for a skin material in the embodiment after heat treatment.

FIG. 4A is a microscopic photograph showing an aspect of the base fabric used for the skin material in Example 1 before heat treatment.

FIG. 4B is a microscopic photograph showing an aspect of the base fabric used for the skin material in Example 1 after heat treatment.

FIG. 5A is a microscopic photograph of the base fabric surface of the skin material of Example 1 taken after buffing of the base fabric surface.

FIG. 5B is a microscopic photograph of the base fabric surface of the skin material of Comparative Example 1 taken after buffing of the base fabric surface.

### DESCRIPTION OF INVENTION

Hereinafter, the invention will be described in detail.

### [Skin Material]

The skin material according to the invention is a skin material containing, in the following order: a base fabric containing fibers having a synthetic resin coating layer, wherein fibers adjacent to each other in the base fabric are at least partially fused with each other; and an adhesive layer and a skin layer, which are provided at a surface of at least one side of the base fabric in this order, the skin material having a plurality of ventilation holes passing through the skin material in a thickness direction.

Here, the description “fibers adjacent to each other are at least partially fused with each other” includes an aspect wherein at least some of the fibers adjacent to each other in the fibers contained in the base fabric are fused with each other at at least a part of each fiber. Fraying of the base fabric in the perforation step can be effectively suppressed if at least some of many fibers having a synthetic resin coating layer contained in the base fabric are fused with each other, at an area where the at least some of many fibers are in contact with each other, that is, at least a part of the fibers.

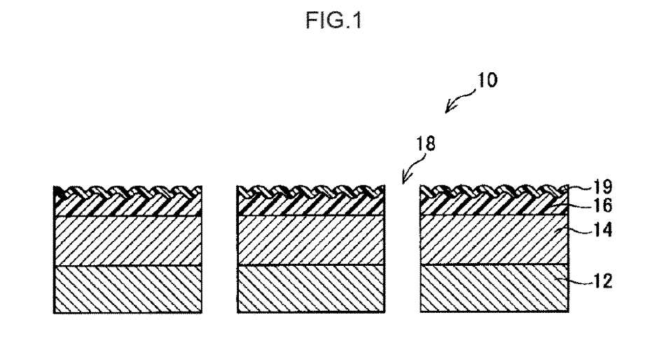

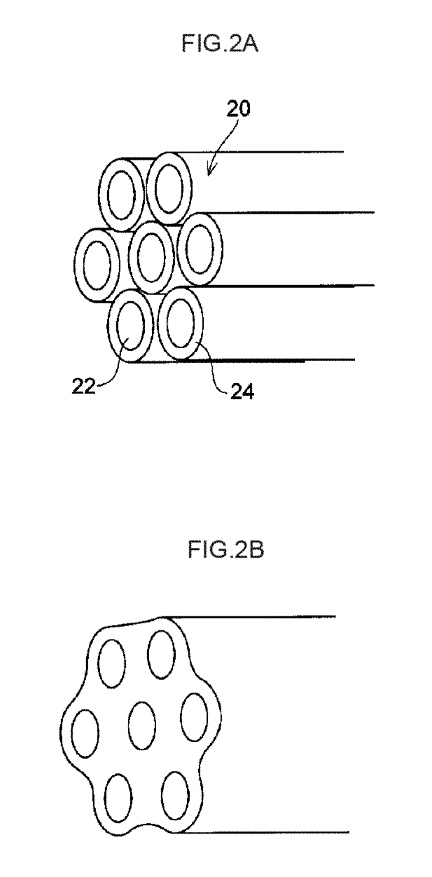

FIG. 1 is a schematic cross-sectional view of one aspect of the skin material 10 according the invention. FIGS. 2A and 2B are schematic views of one aspect of the fibers contained in the base fabric of the skin material according to the invention.

The skin material 10 of the embodiment contains, in the following order: a base fabric 12 containing fibers 20 having a synthetic resin coating layer 24, wherein fibers adjacent to each other are at least partially fused with each other; an adhesive layer 14 and a skin layer 16, which are provided at a surface of at least one side of the base fabric 12 in this order from the base fabric 12, the skin material 10 having a plurality of ventilation holes 18 passing through the skin material in a thickness direction.

In the present embodiment, a surface treatment layer 19 is provided at a surface of the skin layer 16 for the purpose of improving the appearance of the skin material 10 and abrasion resistance of the surface. However, the surface treatment layer 19 is not necessarily required.

In this specification, a base fabric which contains fibers having a synthetic resin coating layer and which is in a state before the fibers are fused with each other by heat treatment is sometimes referred to as “fabric” for the sake of convenience, so as to distinguish the “fabric” from a “base fabric” which is in a state after the fibers are fused with each other by heat treatment.

The inventers consider the action of the invention as follows, although the action of the invention is not clear.

The skin material according to the invention employs a base fabric containing fibers having a synthetic resin coating layer. By heat-treating the base fabric in any process of the processes of forming a skin material, the fibers having a synthetic resin coating layer contained in the base fabric are at least partially fused with each other, so that a base fabric which is hard to fray is formed. Consequently, it is considered that, the skin material according to the invention which is configured by forming through-holes on a layered body provided with, at a base fabric, an adhesive layer and a skin layer in this order, the base fabric being hard to fray, allows for suppression of significant decrease in the strength of the base fabric caused by the formation of the through-holes, and suppression of deterioration in appearance caused by fraying of the fibers contained in the base fabric at the periphery of the through-holes, whereby a skin material having sufficient strength for a skin material and having excellent appearance of the ventilation holes is obtained.

The base fabric may be obtained by preliminarily heat-treating a fabric containing fibers having a synthetic resin coating layer. The base fabric used for the invention may also be formed by layering an adhesive layer and a skin layer on a fabric before heat treatment, and thereafter carrying out heat treatment. It is considered that, similarly to the case where the base fabric is preliminarily formed by heat treatment, an effect of improving the strength of the base fabric due to fusing of the fibers with each other and an effect of suppressing fraying of the fibers contained in the base fabric can also be obtained by carrying out heat treatment after layering.

In the method for producing the skin material according to the invention, a skin layer is formed at a surface of the base fabric by a dry method. Consequently, it is considered that a skin material obtained by the method for producing according to the invention allows for suppression of decrease in the strength of the base fabric caused by a perforation step for forming through-holes, and suppression of fraying of the fibers constituting the base fabric, as well as obtaining lightness, excellent handling, high moisture permeability and breathability, sufficient strength as a skin material, and favorable appearance of ventilation holes.

[Base Fabric]

As shown in the schematic view in FIG. 2A by way of an example, fibers 20 contained in a base fabric 12 of a skin material 10 according to the invention is preferably in a form of a composite fiber having a so-called core-sheath structure, having a synthetic resin coating layer 24 as a sheath portion, around a core fiber 22 as a base material. FIG. 2B is a schematic view of a state in which the synthetic resin coating layer 24 of the fibers 20 shown in FIG. 2A is melted by heat treatment and a plurality of the fiber 20 are fused with each other.

In the case in which the fibers 20 have a core-sheath structure, the core fiber 22 is not particularly limited and any fiber may be used as long as the fibers can be generally used for a skin material such as synthetic leather.

As the core fiber 22, for example, at least one selected from the group consisting of a polyester fiber, a polyamide fiber, a polyurethane fiber, a rayon fiber, a nylon fiber, and a cotton fiber is preferable. In particular, the core fiber 22 is preferably a polyester fiber from the viewpoint of strength and flexibility.

The core fiber 20 may be a fiber consisting of a single kind of fiber, or a blended fiber containing two or more kinds of fibers.

A thickness of the core fiber 22 constituting the fibers 20 contained in the base fabric 12 is not particularly limited. From the viewpoint of achieving both strength and flexibility, the thickness of the core fiber 22 is preferably from 56 dtex to 167 dtex. Further, in a case of forming a twisted yarn, it is preferable that the fiber is formed in the range of from 17 filaments to 72 filaments.

The fibers 20 contained in the base fabric 12 are preferably fibers 20 having a synthetic resin coating layer 24 around the core fiber 22. The synthetic resin coating layer 24 of the fibers 20 does not necessarily need to cover the entire periphery of the core fiber 22.

A synthetic resin used for forming the synthetic resin coating layer 24 is preferably a synthetic resin having a melting point lower than that of a fiber constituting the core fiber 22.

As the synthetic resin used for forming the synthetic resin coating layer, a synthetic resin having a melting point of from 120° C. to 180° C. is preferable. More specifically, examples of the synthetic resin include a polypropylene and a low melting point polyester, and a low melting point polyester is preferable.

Although a melting point of a polyester fiber is generally from 255° C. to 260° C., there is a polyester having a melting point from about 80° C. to 180° C. as a low melting point polyester. Examples of commercially available products of the low melting point polyester include Polyester SP 170 (melting point 83° C.) manufactured by The Nippon Synthetic Chemical Industry Co., Ltd., and the like. Such a low melting point polyester resin may be used as a resin for forming a synthetic resin coating layer.

A thickness of the synthetic resin coating layer 24 is not particularly limited as long as fibers 20 adjacent to each other can be fused. The thickness of the synthetic resin coating layer 24 is preferably in the range of from 2 μm to 10 μm as an average thickness.

As a method for measuring the thickness of the synthetic resin coating layer 24, for example, a method may be employed in which a cross section of the base fabric before heat treatment is photographed as an enlarged photograph using an electron microscope or the like, and the thickness of the synthetic resin coating layer is measured using the image of the enlarged photograph.

A fabric forming the base fabric may be a fabric containing only fibers 20 having a core-sheath structure and having a synthetic resin coating layer 24, or may be a fabric containing a blended fiber containing fibers 20 having a core-sheath structure and having a synthetic resin coating layer 24, and fibers not having a synthetic resin coating layer.

Here, as the fibers not having a synthetic resin coating layer, fibers made of a synthetic resin used for forming the synthetic resin coating layer 24, that is, fibers which may be softened or melted by heat treatment for fusing the fibers 20 at least partially, may be used.

From the viewpoint of more effectively suppressing fraying of the base fabric 12 when ventilation holes 18 are formed on the skin material 10, the base fabric 12 preferably has a high content of fibers 20 having a core-sheath structure and having a synthetic resin coating layer 24, as fibers constituting the base fabric 12, and more preferably contains only fibers 20 having a core-sheath structure and having a synthetic resin coating layer 24.

The fibers 20 having a core-sheath structure and having the synthetic resin coating layer 24 used for forming the base fabric may be made of only one kind, or two or more kinds of fibers 20 having a core-sheath structure which are different from each other may be used in combination.

Examples of an aspect of the fibers 20 having a core-sheath structure which are different from each other include an aspect in which types of the core fiber 22 contained in the fibers 20 are different, an aspect in which synthetic resins used for forming the synthetic resin coating layer 24 are different, and an aspect in which thicknesses of the synthetic resin coating layer 24 are different.

A base fabric used for the skin material according to the invention is a base fabric in which fibers adjacent to each other, among fibers contained in a fabric obtained by knitting or weaving using a yarn containing fibers 20 having the synthetic resin coating layer 24, are at least partially fused with each other.

The fabric used for forming the base fabric 12 may be a woven fabric or a knitted fabric. As described above, an aspect of the woven fabric and the knitted fabric used for the base fabric before the fibers are fused with each other by heat treatment may be simply referred to as a “fabric”. A fabric in the present specification is used in a sense encompassing a woven fabric and a knitted fabric.

The fibers 20 contained in the base fabric 12 may be in a form of a twisted yarn or a single yarn such as a monofilament.

In addition, by heating a twisted yarn containing the core-sheath fiber 20, the twisted yarn may become in a state of monofilament due to fusing of the fibers constituting the twisted yarn, depending on the conditions. A monofilament fiber thus formed may also be used as the fibers contained in the base fabric 12 used in the invention.

The base fabric 12 may be prepared by weaving or knitting yarns containing the fibers 20 having the synthetic resin coating layer 24 around the core fiber 22 to prepare a fabric, and subjecting the thus prepared fabric to heat treatment.

In the skin material according to the invention, “a base fabric comprising fibers having a synthetic resin coating layer, wherein fibers adjacent to each other in the base fabric are at least partially fused with each other” may be obtained by heat treatment of a fabric which is prepared by knitting or weaving with use of the fibers 20 having the synthetic resin coating layer 24 around the core fiber 22 and optionally in combination with fibers which do not have a synthetic resin coating layer, at a temperature higher than a softening point of the synthetic resin constituting the synthetic resin coating layer 24, more preferably, at a temperature near a melting point of the synthetic resin, for example, 80° C. to 190° C. By the heat treatment, the fibers 20 having the synthetic resin coating layer contained in the fabric are fused with each other at least partially, and the fibers 20 are fixed to each other, whereby the base fabric 12 used for the skin material according to the invention may be obtained.

After forming the fabric as a woven or knitted fabric, the fabric may be optionally dyed before the fibers are at least partially fused by the heat treatment. The dyeing may be carried out in a form of a fabric or in a form of a yarn constituting the fabric.

By dying the fabric before the heat treatment, a base fabric 12 having a color for a desired purpose may be obtained.

Note that, as will be described in detail in the following production method, the heat treatment for fusing the fibers at least partially may be performed at any point before the perforation step, as long as the fibers contained in the base fabric 12 are fused with each other at least partially before the perforation step. The heat treatment for fusing the fibers at least partially may be performed, for example, on a fabric before forming the adhesive layer and the skin layer or on a fabric after forming the adhesive layer and the skin layer thereon.

A thickness of the base fabric 12 and a density of the knit structure or the weave structure of the base fabric 12 may be appropriately selected according to the intended use of the skin material 10.

For example, when the skin material 10 according to the invention is used as a skin material of a seat, the thickness of the base fabric 12 is preferably from 0.5 mm to 1.2 mm, from the viewpoint of further improving its flexibility and strength.

As a fabric used for forming the base fabric 12, a commercially available product may be used. Examples of the commercially available fabric that can be used for forming the base fabric in the skin material according to the invention include T7407 (trade name) manufactured by Toyo Senko Corp. and BELLCOUPLE (registered trademark) manufactured by KB Seiren Ltd. The T7407 (trade name) is a fiber having a synthetic resin coating layer containing a low melting point polyester around a polyester fiber as a core fiber.

[Skin Layer]

The skin material 10 according to the invention has a skin layer 16 at a surface of at least one side of the base fabric 12 described above with an adhesive layer 14 interposed therebetween.

Designability according to an intended use of the skin material 10 may be imparted to the skin layer 16. A method for forming the skin layer 16 is not particularly limited, and the skin layer may be provided by applying a method for forming a skin layer used for known synthetic leather and a known skin material.

A synthetic resin used for forming the skin layer 16 is not particularly limited and may be appropriately selected according to the purpose for use. Examples of the synthetic resin used for forming the skin layer 16 include a polyurethane, an acrylic resin, and a polyester. Among them, a polyurethane is preferable from the viewpoint of favorable durability and elasticity.

Examples of the polyurethane used for forming the skin layer 16 include a polycarbonate-based polyurethane, a polyether-based polyurethane, a polyester-based polyurethane, and a modified product thereof. From the viewpoint of using the skin material according to the invention for applications requiring long-term durability, such as automobile seats, chairs, etc., a polycarbonate-based polyurethane is suitable as the polyurethane used for the skin material.

As the polyurethane, a commercially available product may be used, and for example, CRISVON manufactured by DIC Corporation is preferably used.

When a polyurethane is used for forming the skin layer 16, the polyurethane has a hardness of preferably from 98 N/cm² to 3500 N/cm² at 100% modulus, more preferably from 196 N/cm² to 588 N/cm², measured in accordance with JIS K-6301.

As a method for adjusting the hardness (100% modulus) of the polyurethane, for example, when softening is desired, such softening may be achieved by increasing the proportion of the polyol component as a soft segment or increasing the molecular weight of the polyol used for the synthesis of the polyurethane. In addition, when hardening of the polyurethane is desired, a method for hardening includes a method of increasing urethane bonds or urea bonds which form a hard segment, and a method of imparting energy to form a cross-linked structure in the polyurethane, adding a crosslinking agent such as hexamethylene diisocyanate (HDI), hydrogenated xylylene diisocyanate (hydrogenated XDI), isophorone diisocyanate (IPDI) or dicyclohexylmethane diisocyanate (hydrogenated MDI).

A thickness of the skin layer 16 is appropriately selected according to an intended use of the skin material 10. In general, an amount applied before drying (hereinafter sometimes referred to as wet application amount) is preferably approximately from 20 μm to 300 μm, and more preferably from 100 μm to 250 μm by wet application amount.

A composition for forming the skin layer may contain, in addition to a synthetic resin which is a main ingredient, a known additive for the purpose of imparting various functions to the skin layer 16, such as improving the touch, as long as effects of the invention are not impaired.

Examples of the additive that may be used in the composition for forming the skin layer include a crosslinking agent, a crosslinking accelerator, a coloring agent, a film forming aid, a flame retardant, a foaming agent, and the like.

For example, by including a coloring agent in the skin layer 16, designability is improved. Further, improvement in flame retardancy of the skin material 10 may be sought for by adding a known flame retardant such as a phosphorus-based retardant, a halogen-based retardant, an inorganic metal-based retardant, or the like to the skin layer 16.

A method for applying the composition for forming a skin layer on a surface of a releasing material for emboss pattern transfer or on a surface of a smooth releasing material may be a method in which a composition for forming a skin layer is applied on a surface of a releasing material and dried, or may be a transfer method. In a case in which a releasing material for emboss pattern transfer is used as a releasing material, a transfer method may be applied when there is no hindrance to the emboss pattern transfer.

[Adhesive Layer]

The skin layer 16 is adhered to the base fabric 12 with the adhesive layer 14 interposed therebetween.

An adhesive constituting the adhesive layer 14 is not particularly limited. Examples of the adhesive that may be used for forming the adhesive layer 14 include an adhesive containing a polyurethane, a vinyl chloride resin, an acrylic resin or the like.

More specifically, examples of the adhesive include preferably, for example, (1) a two-pack curable polyester-based adhesive, (2) a two-pack curable polyurethane-based adhesive, (3) a two-pack curable acrylic adhesive, and the like.

(2) The two-pack curable polyurethane-based adhesive may be any one of a two-pack curable polyether-based polyurethane adhesive, a two-pack curable polyester-based polyurethane adhesive, and a two-pack curable polycarbonate-based polyurethane adhesive.

The adhesive used for forming the adhesive layer is also available as a commercially available product, preferable examples of which include Adhesive No. 3660 for welding [two-pack curable polyurethane adhesive: manufactured by No-tape Industrial Co., Ltd.], DAIKALAC 7250NT [two-pack curable polyester adhesive: manufactured by Daido Chemical Corp.], TA265 [two-pack curable polyether adhesive, manufactured by DIC Corporation], CRISBON TA205 [polycarbonate-based polyurethane adhesive: manufactured by DIC Corporation], and the like.

A composition used for forming an adhesive layer may contain various additives in addition to the above-mentioned adhesive depending on the purpose as long as effects of the invention are not impaired.

Examples of the additives include colorants, flame retardants, foaming agents and the like.

By including a flame retardant such as a phosphorus-based flame retardant in the adhesive layer 14, flame retardancy of the skin material 10 is improved. However, when the content of the flame retardant is too large, there is a possibility that the flexibility of the obtained adhesive layer will be lowered. Therefore, the content of the flame retardant when used is preferably 5% by mass or less with respect to the content of the adhesive.

[Other Layers]

In the skin material 10 according to the invention, any other optional layer in addition to the base fabric 12, the adhesive layer 14, and the skin layer 16 may be provided as long as effects of the invention are not impaired.

Examples of the “other layer” include an intermediate layer, a surface treatment layer, and the like.

The surface treatment layer 19 is formed by applying a surface treatment agent composition containing an aqueous emulsion resin or a dispersion resin to a surface of the skin layer 16.

As a resin contained in the aqueous emulsion resin or the dispersion resin used for forming the surface treatment layer 19, any resin may be used as long as it can form a uniform emulsion in an aqueous medium or a non-aqueous organic solvent. Examples of the resin that may be used for forming the surface treatment layer include preferably, for example, a polyurethane, an acrylic resin, an elastomer, and the like, and more preferably, a polyurethane.

Examples of the aqueous medium include water, an alcohol, etc., and a mixed medium obtained by mixing two or more of the above. An aqueous solvent is preferably water, a mixed solvent containing 90% to 99% by mass of water and 10% to 1% by mass of alcohol, and the like.

Examples of the non-aqueous organic solvent include dimethylformamide (DMF), methyl n-butyl ketone (MBK), isopropyl alcohol (IPA), toluene, etc., and a mixed solvent obtained by mixing two or more of the above.

By forming the surface treatment agent layer 19 at a surface of the skin layer 16, external appearance is improved. In the surface treatment layer 19, a crosslinking agent, an organic filler, a lubricant, a flame retardant, and the like may be contained.

For example, by containing an organic filler, a lubricant or the like in the surface treatment layer 19, a smooth touch is imparted to the skin material 10, and the abrasion resistance is further improved.

In the skin material 10 according to the invention, an intermediate layer may be provided between the adhesive layer 14 and the skin layer 16. A resin used for forming the intermediate layer is not particularly limited. Examples of the resin used for forming the intermediate layer include a polyurethane, an acrylic resin and the like, and a polyurethane is preferable.

Examples of the polyurethane used for the intermediate layer include a polycarbonate-based polyurethane, a polyether-based polyurethane, a polyester-based polyurethane, and a modified product thereof. When the skin material 10 requires long-term durability, a polycarbonate-based polyurethane is suitable as the polyurethane used for the intermediate layer.

A thickness of the polyurethane intermediate layer may be in the range of from 10 μm to 200 μm. The thickness of the polyurethane intermediate layer is preferably in the range of from 10 μm to 100 μm, and more preferably in the range of from 30 μm to 60 μm.

A hardness of the polyurethane used as the intermediate layer is suitably from 98 N/cm² to 1176 N/cm² at 100% modulus.

The skin material according to the invention contains a base fabric containing fibers having a synthetic resin coating layer, wherein fibers adjacent to each other are at least partially fused with each other, and has ventilation holes formed by perforating a layered body in which an adhesive layer and a skin layer are provided at a surface of the base fabric in this order. Therefore, the skin material according to the invention has a high-quality texture, moisture permeability and breathability, and thus the skin material has less stuffiness even when used when in contact with a human body, is excellent in comfort, is lightweight, has sufficient strength, and is excellent in appearance of the ventilation holes.

The skin material according to the invention may be used as synthetic leather suitable for automobile interior parts, interior parts for railway vehicles and aircraft, footwear, in particular, shoes, seat for chair upholstery, or interior materials, and its range of application is wide. The skin material according to the invention is particularly suitable as a skin material for seats for automobiles, chairs and the like.

[Method for Producing Skin Material]

Next, a method for producing the skin material according to the invention will be described.

The skin material according to the invention is preferably produced by a method for producing a skin material according to the invention described in detail below.

The skin material 10 according to the invention is produced by a method including the steps of:

layering a skin layer 16 and an adhesive layer 14 in this order at a surface of a releasing material from a side of the releasing material;

preparing a base fabric 12 containing fibers 20 having a synthetic resin coating layer 24;

adhering the base fabric 12 and the adhesive layer 14 to each other by bringing the adhesive layer 14 of the releasing material, which is layered with the skin layer 16 and the adhesive layer 14, into contact with a surface of at least one side of the base fabric 12;

heating the base fabric 12, the adhesive layer 14, the skin layer 16, and the releasing material to form the adhesive layer 14, the skin layer 16, and the releasing material, in this order from the base fabric 12, at a surface of at least one side of the base fabric 12, and peeling off the releasing material from a surface of the skin material 14 to form a layered body;

perforating the layered body to form a plurality of ventilation holes 18 passing through the layered body in a thickness direction; and

carrying out heating to a temperature equal to or higher than a softening temperature of a synthetic resin contained in the synthetic resin coating layer 24 to fuse, at least partially with each other, fibers 22 having the synthetic resin coating layer 24, the heating being carried out before the step of perforating the layered body to form the ventilation holes 18.

The production method according to the invention is characterized by including a step of heating a fabric containing fibers 20 having a synthetic resin coating layer 24 so that the fibers 22 having the synthetic resin coating layer 24 are at least partially fused with each other, and a step of forming a skin layer 16, which is previously formed on a surface of a releasing material, and an adhesive layer 14, which are then brought into contact with the base fabric 12, the adhesive layer 14 and the skin layer 16 being formed at the base fabric by a dry method.

(Step of Providing a Skin Layer and an Adhesive Layer at a Surface of a Releasing Material)

First, a skin layer 16 is formed on s surface of a releasing material.

As the releasing material, a known releasing material may be appropriately selected and used according to the purpose. For the releasing material, a releasing material for emboss pattern transfer may be used, and a smooth releasing material may also be used.

As a method for forming the skin layer 16 on a surface of the releasing material, a known method may be applied. In general, examples of the method for forming the skin layer 16 include a method in which a composition for forming a skin material described above is applied to a surface of the releasing material and dried to form the skin layer 16. Further, when there is no hindrance to the emboss pattern transfer, the skin layer 16 may be provided on a surface of the releasing material by a transfer method.

An arbitrary leather-like uneven pattern (emboss) may be provided on a surface of the skin layer 16.

The emboss may be obtained by, after forming the skin layer 16 at the base fabric 12 with the adhesive layer 14 interposed therebetween, or after pressure-bonding the base fabric 12 and a layered body including the skin layer 16 and heating to cure the adhesive layer 14, thermocompressing an emboss pattern transfer roll having an emboss pattern. Further, the emboss may be formed by forming the skin layer 16 and the adhesive layer 14 at a surface of a releasing material for emboss pattern transfer in which an emboss pattern is formed in advance, placing the adhesive layer 16 thus formed and the base fabric 12 so as to bring the adhesive layer 16 and the base fabric 12 into contact with each other, followed by pressure-bonding, heating, and peeling off the releasing material for emboss pattern transfer.

Any releasing material for emboss pattern transfer may be used as long as the releasing material has a desired emboss pattern. For example, a commercially available releasing material for emboss pattern transfer may be used, and a releasing material having a desired emboss pattern formed on a surface of the releasing material using computer graphics techniques or the like may be used.

The adhesive layer 14 is formed by applying a composition for forming the aforementioned adhesive layer at a surface of the skin layer 16. A method for applying the composition for forming the adhesive layer at a surface of the skin layer 16 may be a coating method or a transfer method.

In this way, a layered body having the skin layer 16 and the adhesive layer 14 in this order at a surface of the releasing material is formed.

(Step of Preparing a Fabric Containing Fibers Having a Synthetic Resin Coating Layer)

In this step, in order to produce a base fabric 12 of the skin material according to the invention, a fabric containing fibers 20 having a synthetic resin coating layer 24 is prepared.

Preparing the fabric may include a step of preparing a fabric with a yarn containing fibers 20 having a synthetic resin coating layer 24.

Further, as described above, preparing the fabric may be a step of preparing a commercially available fabric containing fibers 20 having a synthetic resin coating layer 24.

Details of the fibers 20 having a synthetic resin coating layer 24 and a core fibers 22 are as described in the description of the skin material.

This step may include a step of dyeing a prepared fabric or an obtained fabric. The dyeing may be carried out for a yarn prior to making a fabric, and thereafter a fabric having a desired hue may be prepared with the dyed yarn.

It is preferable that a heating step which will be described later is carried out after this step, to prepare in advance the base fabric 12 containing fibers having a synthetic resin coating layer, wherein fibers adjacent to each other are at least partially fused with each other, and thereafter a next step is carried out in which a base fabric 12 and an adhesive layer 14 of a layered body provided with a skin layer 16 and the adhesive layer 14 at a surface of a releasing material are adhered to each other. The heating step is preferably carried out after an optional step of dyeing the base fabric 12.

Either of the step of providing the skin layer and the adhesive layer a surface of the releasing material or the step of preparing the base fabric may be performed earlier. Further, the step of providing the skin layer and the adhesive layer and the step of preparing the base fabric may be respectively performed in parallel as a separate step.

The layered body which is obtained in advance by these steps and in which the skin layer and the adhesive layer are provided at a surface of the releasing material, and the base fabric, are adhered to each other in a subsequent step, so that the adhesive layer 14 and the skin layer 16 are formed on the base fabric 12 by a dry method.

(Step of Adhering the Base Fabric and the Adhesive Layer to Each Other by Bringing the Adhesive Layer of the Releasing Material, which is Layered with the Skin Layer and the Adhesive Layer, into Contact with a Surface of at Least One Side of the Base Fabric)

In this step, pressure-bonding is performed by bringing a side of the adhesive layer 14 of the layered body obtained as described above into contact with a surface of either one side of the base fabric 12 formed in advance, or with a surface of either one side of the fabric before heat treatment.

Heat treatment may be performed at the time of the pressure-bonding or may be performed after the pressure-bonding. The heat treatment in this step is performed for the purpose of curing the adhesive layer 14.

A pressure for pressurizing the layered body and the base fabric is preferably from 10 MPa to 50 MPa, and more preferably from 15 MPa to 30 MPa. The pressurization is carried out preferably after formation of the adhesive layer 14 at the skin layer 16 and before the adhesive layer is cured, from the viewpoint of further improving peeling strength between the base fabric 12 and the skin layer 16 of the skin material 10.

The heating of the layered body containing the base fabric 12 or a fabric, the adhesive layer 14 and the skin layer 16 may be carried out by a known method. There is no particular limitation on the heating means, and any known heating means such as heating using a heat roll, hot air heating, and heating in a heating drier may be used.

A heating temperature is preferably a temperature that does not affect the core fiber 22, the adhesive layer 14, and the skin layer 16 contained in the fabric.

The heating temperature for heating the layered body containing the base fabric 12 or a fabric, the adhesive layer 14 and the skin layer 16 to cure the adhesive layer or the like is preferably, for example, in the range of from 40° C. to 70° C., and more preferably in the range of from 40° C. to 60° C. Heating time is preferably 24 hours or more under the above temperature condition.

As for the temperature condition and heating time of the heat treatment, appropriate conditions may be selected depending on the synthetic resin used for forming the skin layer 16 and the adhesive layer 14, the type of fibers used for the base fabric 12, and the like.

By the heat treatment in this step, a resin contained in the adhesive layer 14 is sufficiently cured. In some cases, the skin layer 16 may be cured before applying the composition for forming the adhesive layer 14. The curing of the resin contained in the skin layer 16 may further proceed in the already cured skin layer 16 by the heating step for curing the adhesive layer 14.

By the heat treatment in this step, a cured adhesive layer 14 is formed between the base fabric 12 or a fabric and the skin layer 16.

In a case of using a releasing material for emboss pattern transfer to form an emboss pattern on the skin layer 16, a skin layer 16 having an emboss pattern on its surface is formed at the base fabric 12 or a fabric, with the adhesive layer 14 interposed therebetween, by peeling off the releasing material for emboss pattern transfer after the heat treatment.

Other methods for forming an emboss pattern on a surface of the skin layer 16 include a method in which a layered body is obtained by forming the skin layer 16 and the adhesive layer 14 at a surface of a smooth releasing material, using a smooth releasing material having no emboss pattern instead of the releasing material for emboss pattern transfer, and the smooth releasing material is peeled off, and thereafter the skin layer 16 and a releasing material for emboss pattern transfer (an emboss roll for forming an emboss pattern) are contacted to each other and subjected to thermal emboss process, whereby an emboss pattern is formed on a surface of the skin layer 16.

It is preferable that the heat treatment performed in the present step of adhering the base fabric 12 and the adhesive layer 14 to each other is carried out promptly after the skin layer 16 and the adhesive layer 14 are formed at the releasing material.

Specifically, it is also one of preferred embodiments that the base fabric 12 or a fabric and the adhesive layer 14 are adhered to each other before the adhesive layer 14 is cured, and thereafter the heat treatment is performed.

When the adhesive layer 14 formed at a surface of the skin layer 16 comes into contact with the base fabric 12 or a fabric before the adhesive layer is cured, and adhesion under pressure is undergone, it becomes easier for some or a part of the fibers 20 contained in in the base fabric 12 to ingress into the adhesive layer 14, whereby adhesiveness between the adhesive layer 14 and the base fabric 12 is improved. Moreover, by subsequent heat treatment, adhesiveness toward the base fabric 12 is improved by the curing process of the adhesive layer 14, and in the skin layer 10 thus obtained, peeling strength between the base fabric 12 and the skin layer 16 is further improved.

After the adhesion layer 14 and the skin layer 16 are cured by the heat treatment, the releasing material is peeled off from the surface of the skin layer 16, whereby a layered body is obtained.

(Heating Step of Carrying Out Heating to a Temperature Equal to or Higher than a Softening Temperature of a Synthetic Resin Contained in the Synthetic Resin Coating Layer to Fuse, at Least Partially with Each Other, Fibers Having the Synthetic Resin Coating Layer)

In the production method according to the invention, prior to the step of perforating the layered body to form ventilation holes described later, a heating step of carrying out heating to a temperature equal to or higher than a softening temperature of a synthetic resin contained in the synthetic resin coating layer 24 to fuse, at least partially with each other, fibers 22 having the synthetic resin coating layer 24, is carried out

By this step, fibers 20 having the synthetic resin coating layer 24 contained in the fabric are at least partially fused with each other.

The heating in this step is preferably performed at a temperature equal to or higher than the softening temperature of the synthetic resin contained in the synthetic resin coating layer 24 of the fibers 20.

Appropriate conditions including temperature condition and heating time of the heat treatment in this step may be selected taking into consideration physical properties of the core fiber 22 contained in the fabric, a melting point and a softening point of a synthetic resin contained in the synthetic resin coating layer 24, a desired fusion state of fibers, and the like.

A heating temperature is preferably, for example, in the range of from 80° C. to 190° C., more preferably in the range of from 90° C. to 180° C., and still more preferably in the range of from 120° C. to 180° C. When the softening point of a synthetic resin constituting the synthetic resin coating layer is lower, the heating temperature is more preferably in the range of from 90° C. to 140° C.

A heating time is preferably from 30 seconds to 10 minutes under the above temperature conditions, more preferably from 1 minute to 5 minutes.

This step may be performed at any timing as long as it is before the step of forming ventilation holes by perforation described later.

In particular, it is preferable to carry out the heating to a temperature equal to or higher than a softening temperature of a synthetic resin contained in the synthetic resin coating layer to fuse, at least partially with each other, fibers having the synthetic resin coating layer, after the step of preparing a fabric configured to contain fibers having a synthetic resin coating layer, and before the step of adhering the base fabric and the adhesive layer, considering that the productivity is further improved and that it is less likely that the synthetic resin and the like contained in the skin layer 16 and the adhesive layer 14 are thermally affected.

(Step of Perforating the Layered Body to Form a Plurality of Ventilation Holes Passing Through the Layered Body in a Thickness Direction)

Next, a plurality of ventilation holes 18 passing through the layered body in a thickness direction are formed by perforating the obtained layered body. For example, the perforation is performed using a punching roll, perforating the layered body to form ventilation holes 18 having a desired diameter at desired intervals. A skin material 10 is thereby produced having a multiple of ventilation holes 18 passing therethrough in the thickness direction.

According to the above method, ventilation holes 18 whose openings are almost circular in a planar view can be formed, since, in the base fabric 12 which serves as a support, at least some of the fibers 20 contained in the base fabric are at least partially fused with each other via the synthetic resin coating layer 24, whereby the fibers 20 are solidified and reinforced, and deformation of the layered body at the perforation process is suppressed.

In addition, although the fibers 20 constituting the fabric of the base fabric are cut by the perforation, since the fibers 20 constituting the base fabric 12 are at least partially fused with each other via the synthetic resin coating layer 24, and reinforced by a cured synthetic resin, frayed yarns which were thus cut are less likely to jump into or out of the ventilation holes 18 thereby deteriorating the outer appearance.

Furthermore, in addition to the fusing of at least some of the fibers 20 in the yarns constituting the base fabric 12, there may be a case where yarns constituting a knitted or woven fabric are fused with and fixed to each other at intersections. Thus, the skin material according to the invention using the base fabric 12 according to the invention has more favorable abrasion resistance, and the skin material 10 using the base fabric 12 according to the invention also has an advantage in excellent durability.

Moreover, by forming an adhesive layer and a skin layer in the layered body by a dry method, resin impregnation into a fabric, which occurs in the case of a wet method, does not occur. Therefore, the obtained skin material 10 has additional advantages in that it is lightweight compared with a skin material formed by a wet method, and that a stress required for perforation can be smaller.

Therefore, the skin material according to the invention which is produced by the production method according to the invention described above has ventilation holes and has high moisture permeability and breathability, and sufficient strength as a skin material, and is excellent in the appearance of the ventilation holes.

According to the method for producing a skin material according to the invention, a skin material having a high-quality texture, moisture permeability and breathability can be efficiently produced.

### EXAMPLES

Hereinafter, the invention will be specifically described with reference to Examples, but the invention is not limited thereto.

### Example 1

(1. Formation of Layered Body)

Release paper ARX 196 M (trade name, manufactured by Asahi Roll Co., Ltd.) was used as a releasing material. A composition for forming a skin layer having a solid content of 15 mass % was prepared by diluting a polyurethane (CRISVON NY-324 (trade name), manufactured by DIC Corporation) with a mixed solvent of dimethylformamide/methyl ethyl ketone 1:1 (mass ratio). The obtained composition for forming a skin layer was applied to the surface of the releasing material with a knife coater in an amount of 200 g/m² and dried in a heating drier at 100° C. for 2 minutes to obtain a skin layer 16 at a surface of the releasing material.

Hereinafter, dimethylformamide is sometimes referred to as DMF.

Next, 100 parts by mass of polyurethane (TA 205 (trade name), manufactured by DIC Corporation) was diluted with 5 parts by mass of DMF, and further 10 parts by mass of a crosslinking agent (BURNOCK DN 980, manufactured by DIC Corporation) was added to prepare a composition for forming an adhesive layer.

The resulting composition for forming an adhesive layer was layered and coated in an amount of 150 g/m² on a surface of the skin layer 16 formed on a surface of the releasing material, at the opposite side of the releasing material side, whereby a composition layer for forming an adhesive layer was formed on the skin layer 16.

(2. Preparation of Base Fabric)

As fibers forming a fabric, core-sheath structure fibers 20 having a thickness of 75 d (denier) provided with a polyester fiber as a core fiber 22 and, around the core fiber 22, a synthetic resin coating layer 24 having an average thickness of 3 μm formed with a low melting point polyester (melting point 140° C.), which is a synthetic resin, was used. Using a yarn obtained by twisting 24 fibers (24 yarns) of the core-sheath structure fibers 20, a fabric knitted by denbigh stitch (a knitting density: wale/course: 35/84 [yarns/inch (=2.54 cm)] was prepared.

Thereafter, the fabric was dyed gray using an azo dye, washed with water and dried to obtain a colored fabric. The obtained fabric was heated at 170° C. for 1 minute to obtain a base fabric 12 in which fibers 20 was at least partially fused to adjacent fibers 20.

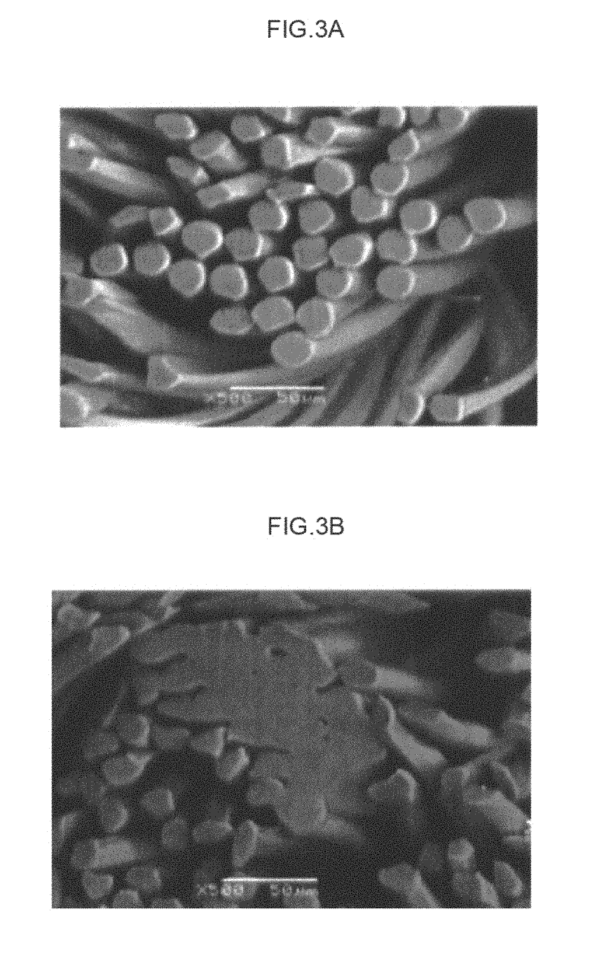

FIG. 3A is an electron microscopic photograph taken of a cross section of the fabric before heating. FIG. 3B is an electron microscopic photograph taken of the cross section of the base fabric under the same conditions after heating. As is apparent from FIGS. 3A and 3B, it is understood that the fibers 20 adjacent to each other of the base fabric 12 were partially fused by the heat treatment.

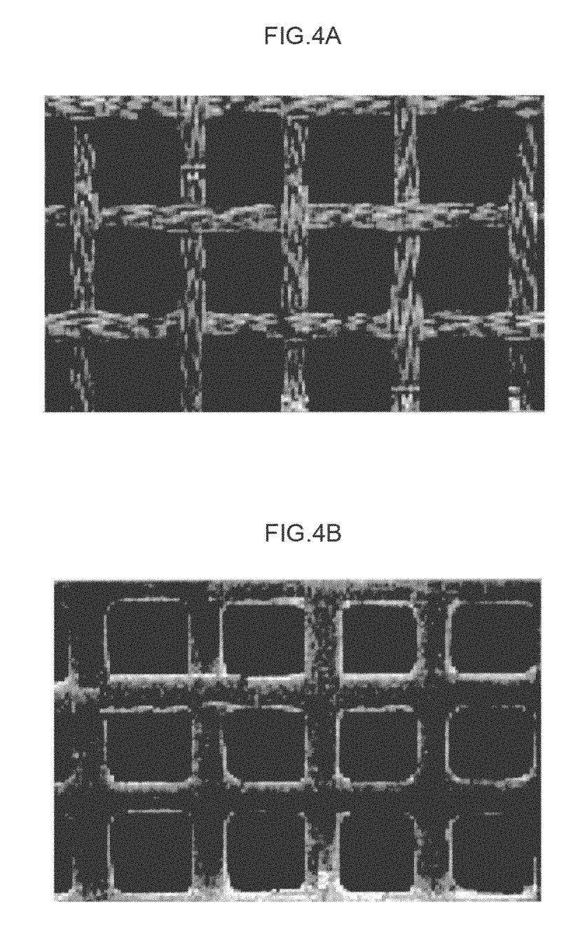

FIG. 4A is an electron microscopic photograph taken of the surface of the fabric before heating. FIG. 4B is an electron microscopic photograph taken of a surface of the base fabric after heating under the same conditions. As is apparent from FIGS. 4A and 4B, it is understood that not only some of the fibers 20 adjacent to each other but also the yarns constituting the base fabric 12 are fused with each other at intersections of the yarns in the base fabric 12 by heat treatment.

(3. Preparation of Layered Body)

After forming a composition layer for forming an adhesive layer, the base fabric 12 obtained above was brought into contact with the composition layer for forming an adhesive layer, and lamination and pressure-bonding was performed at a pressure of 20 MPa. Thereafter, the layered body was allowed to stand for 48 hours in an atmosphere at 50° C., and after the adhesive layer 14 was cured, the releasing material was peeled off to obtain a layered body provided with the skin layer 16 at a surface of the base fabric 12 with the adhesive layer 14 interposed therebetween.

(4. Perforation Step)

Perforation was performed using a punching roll on the layered body (synthetic leather) obtained through the above steps, provided with layers of the base fabric 12, the adhesion layer 14, and the skin layer 16, to obtain a skin material 10 having ventilation holes 18.

The diameter, the intervals and the opening ratio of the ventilation holes 18 in the skin material 10 are as follows:

Ventilation diameter: 1.4 mm

### Pitch: 5.0 mm

Opening ratio: 14%

### Comparative Example 1

A skin material of Comparative Example 1 was prepared in the same manner as in Example 1, except that a tricot satin knitted fabric that was knitted (knitting density: wale/course: 53/45) with a yarn obtained by twisting 24 fibers of a polyester fiber not having a synthetic resin coating layer was used in place of the fabric used for forming the base fabric 12 used in Example 1.

(Evaluation of Skin Material)

The skin materials of Example 1 and Comparative Example 1 were evaluated for breathability, appearance of ventilation holes, appearance of ventilation holes after buffing the base fabric surface, tear strength, flat abrasion resistance, and distortion of ventilation holes, each item being evaluated according to the following method and criteria.

(1. Breathability)

Breathability of the skin materials was measured according to JIS L1096 8.27.1 by the A method, and accessed in a five-grade evaluation system of from 5 points to 1 point according to the following criteria. The results are shown in Table 1 below.

5 points: 130 cc/cm²·s or more
4 points: 100 cc/cm²·s or more and less than 130 cc/cm²·s
3 points: 80 cc/cm²·s or more and less than 100 cc/cm²·s
2 points: 60 cc/cm²·s or more and less than 80 cc/cm²·s
1 point: less than 60 cc/cm²·s

(2. Appearance of Ventilation Holes)

Frayed yarns in the ventilation holes were visually evaluated at ten ventilation holes out of the ventilation holes formed in the skin materials and accessed in a five-grade evaluation system of from 5 points to 1 point according to the following criteria. The results are shown in Table 1 below.

5 points: No frayed yarn is visually confirmed.
4 points: 1 to 2 frayed yarns are visually confirmed.
3 points: 3 to 5 frayed yarns are visually confirmed.
2 points: 6 to 9 frayed yarns are visually confirmed.
1 point: 10 or more frayed yarns are visually confirmed.

(3. Appearance of Ventilation Holes after Buffing Base Fabric Surface)

A back surface, on which a skin layer is not formed, of the base fabric of the skin materials was buffed by rubbing five times using a cotton canvas as an abrasion tester with a load of 2.94 N. Then, the frayed yarns in 10 ventilation holes were visually evaluated from the side of the skin layer, and accessed in a five-grade evaluation system of from 5 points to 1 point according to the following criteria. The results are shown in Table 1 below.

5 points: No frayed yarn was visually confirmed.
4 points: 1 to 2 frayed yarns are visually confirmed.
3 points: 3 to 5 frayed yarns are visually confirmed.
2 points: 6 to 9 frayed yarns are visually confirmed.
1 point: 10 or more frayed yarns are visually confirmed.

In addition, the surface of the base fabric after buffing the skin materials was photographed with a microscope and the condition was observed.

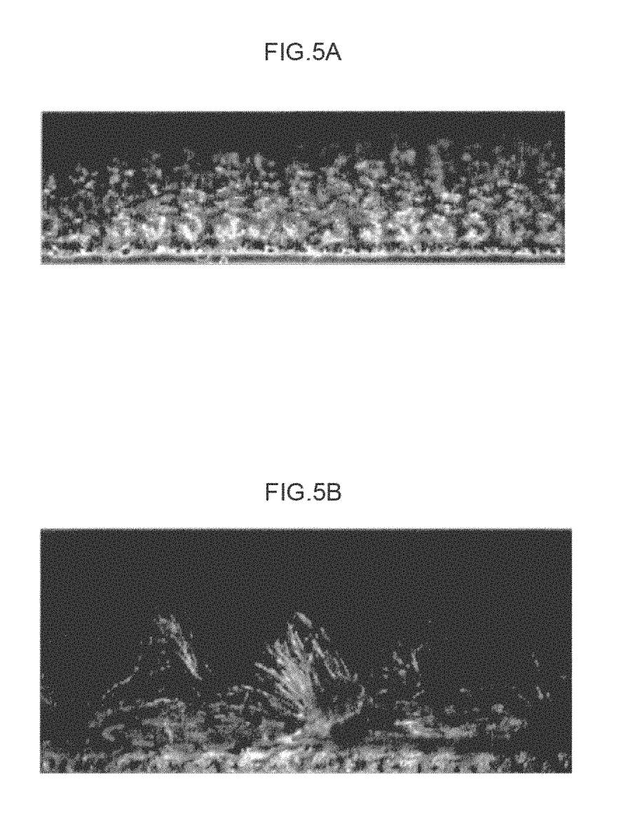

FIG. 5A is a microscopic photograph taken of the base fabric surface of the skin material of Example 1 after buffing the surface of the base fabric. FIG. 5B is a microscopic photograph of a surface of the base fabric of the skin material of Comparative Example 1 after buffing. By comparing FIG. 5A with FIG. 5B, it is understood that, even in the base fabric surface on the back side of the skin material, resistance to buff processing is improved by using the base fabric according to the invention, and that the skin material according to the invention is also excellent in durability of the base fabric side on the back side.

(4. Tear Strength)

Tear strength of the skin material was measured according to JIS L1096 8.15.4 by C method and accessed in a five-grade evaluation system of from 5 points to 1 point according to the following criteria. The results are shown in Table 1 below.

5 points: The tear strength is 100 N or more.
4 points: The tear strength is 80 N or more but less than 100 N.
3 points: The tear strength is 60 N or more but less than 80 N.
2 points: The tear strength is 40 N or more but less than 60 N.
1 point: The tear strength is less than 40 N.

(5. Flat Abrasion Resistance)

The obtained skin material was cut and each test piece having a size of 70 mm in width and 300 mm in length was taken from each of the longitudinal direction and the transverse direction. Then, the test piece is fixed to a flat abrasion tester T-TYPE (manufactured by Daiei Kagaku Seiki MFG Co., Ltd.) together with a urethane foam having a width of 70 mm, a length of 300 mm and a thickness of 10 mm at the back side of the test piece.

The surface of the test piece (the side on which the skin layer is formed) is abraded by applying a load of 9.8 N to an abrasion tester covered with a cotton fabric (cotton canvas). The abrasion tester reciprocates 10000 times at a speed of 60 reciprocations per minute over a width of 140 mm on the surface of the test piece. The cotton canvas overlaid on the abrasion tester is exchanged every 2500 times of the reciprocal abrasion, and the reciprocal abrasion is performed 10000 times in total. The test piece after the abrasion was observed and judged according to the following criteria.

5 points: No change in appearance (no crack and no tear)
4 points: Slight abrasion is observed but inconspicuous.
3 points: Abrasion is clearly observed and fibrous base material is exposed (crack is observed).
2 points: Exposure of fibrous base material is somewhat significant.
1 point: Exposure of fibrous base material is significant (tear is observed).

(6. Vent Distortion)

Distortion of the circle of the opening portion was visually observed with respect to ten ventilation holes out of the ventilation holes formed on a layered sheet and accessed in a five-grade evaluation system of from 5 points to 1 point according to the following criteria. The results are shown in Table 1 below.

5 points: Circular ventilation holes were observed in a planar view.
4 points: A slight distortion was observed in one direction of the circular shape of the ventilation holes in a planar view.
3 points: A slight distortion was observed in a plurality of directions of the circular shape of the ventilation holes in a planar view.
2 points: Ventilation holes with elliptical shape were observed in a planar view.
1 point: Ventilation holes with significant distortion were observed in a planar view.

TABLE 1

| | Example 1 | Comparative Example 1 |
|---|---|---|
| Breathability | 5 | 5 |
| Appearance of ventilation | 5 | 4 |
| holes | | |
| Appearance of ventilation | 5 | 1 |
| holes after buffing the | | |
| surface of base fabric | | |
| Tear strength | 5 | 2 |
| Flat abrasion resistance | 5 | 4 |
| Distortion of ventilation | 5 | 2 |
| holes | | |

As is apparent from Table 1, it is understood that the skin material of Example 1 has the same breathability as that of the skin material of Comparative Example 1, and is excellent in the appearance of the ventilation holes formed by perforation, and is excellent in tear strength and abrasion resistance, compared to the skin material of Comparative Example 1. From the above, it was confirmed that, even though the skin material according to the invention has ventilation holes and favorable breathability, the skin material according to the invention has sufficient strength as a skin material and abrasion resistance, and is excellent in appearance of the ventilation holes.

The disclosure of Japanese Patent Application No. 2015-005630 filed on Jan. 15, 2015 is hereby incorporated by reference. All documents, patent applications, and technology standards described in this specification are incorporated herein by reference to the same extent as in the case in which each individual publication, patent application, and technology standards were specifically and individually indicated to be incorporated by reference.

1. A skin material comprising, in the following order:
a base fabric comprising fibers having a synthetic resin coating layer, wherein fibers adjacent to each other in the base fabric are at least partially fused with each other; and
an adhesive layer and a skin layer, which are provided at a surface of at least one side of the base fabric in this order from the base fabric,
the skin material having a plurality of ventilation holes passing through the skin material in a thickness direction.

2. The skin material according to claim 1, wherein the fibers comprise
at least one kind of core fiber selected from the group consisting of a polyester fiber, a polyamide fiber, a polyurethane fiber, a rayon fiber, a nylon fiber, and a cotton fiber, and
a synthetic resin coating layer comprising a synthetic resin having a melting point of from 120° C. to 180° C.

3. The skin material according to claim 1, wherein the base fabric is obtained by fusing, at least partially with each other, fibers adjacent to each other, the fibers adjacent to each other being among fibers comprised in a fabric obtained by knitting or weaving using a yarn comprising the fibers having the synthetic resin coating layer.

4. A method for producing a skin material, comprising the steps of:
layering a skin layer and an adhesive layer, in this order, at a surface of a releasing material, from a side of the releasing material;
preparing a base fabric comprising fibers having a synthetic resin coating layer;
adhering the base fabric and the adhesive layer to each other by bringing the adhesive layer of the releasing material, which is layered with the skin layer and the adhesive layer, into contact with a surface of at least one side of the base fabric;
heating the base fabric, the adhesive layer, the skin layer, and the releasing material to form the adhesive layer, the skin layer, and the releasing material, in this order from the base fabric, at a surface of at least one side of the base fabric, and peeling off the releasing material from a surface of the skin material to form a layered body;
perforating the layered body to form a plurality of ventilation holes passing through the layered body in a thickness direction; and
carrying out heating to a temperature equal to or higher than a softening temperature of a synthetic resin comprised in the synthetic resin coating layer to fuse, at least partially with each other, fibers having the synthetic resin coating layer, the heating being carried out before the step of perforating the layered body to form the ventilation holes.

5. The method for producing a skin material according to claim 4,
wherein the step of preparing the base fabric comprising the fibers having the synthetic resin coating layer is a step of preparing the base fabric using a yarn comprising the fibers having the synthetic resin coating layer, and
wherein the step of carrying out heating to a temperature equal to or higher than a softening temperature of a synthetic resin comprised in the synthetic resin coating layer to fuse, at least partially with each other, fibers having the synthetic resin coating layer is carried out after the step of preparing the base fabric and before the step of adhering the base fabric and the adhesive layer to each other.

6. The skin material according to claim 1, wherein the fibers are in a form of a twisted yarn.

7. The skin material according to claim 6, wherein the twisted yarn comprises from 17 filaments to 72 filaments.

8. The skin material according to claim 2, wherein the core fiber is a polyester fiber.

9. The skin material according to claim 1, wherein the synthetic resin coating layer comprises a low melting point polyester having a melting point from about 80° C. to about 180° C.
